(19) United States
(12) Patent Application Publication
(10) Pub. No.: US 2009/0300194 A1
(43) Pub. Date: Dec. 3, 2009

(54) CONTENT DISTRIBUTION SERVER AND CONTENT DISTRIBUTION METHOD

(76) Inventor: Koichi OGASAWARA, Kanagawa (JP)

Correspondence Address: FROMMER LAWRENCE & HAUG LLP, 745 FIFTH AVENUE, NEW YORK, NY, 10151, US

(21) Appl. No.: 12/473,794

(22) Filed: May 28, 2009

(30) Foreign Application Priority Data
May 29, 2008 (JP) P2008-141306

(51) Int. Cl. G06F 15/173

(52) U.S. Cl. 709/228

(57) ABSTRACT

Disclosed herein is a content providing server, including, a content distribution processing block configured to distribute, in multicast distribution, content data at least one reception terminal via a predetermined transmission path, and a content reception processing block configured, in reception of a content distribution request via a predetermined connection line, to execute, via the connection line, callback on a content providing terminal that issued the received content distribution request and distribute, in multicast, content data obtained in a session connected by the callback from the content distribution processing block to the reception terminal.

### BACKGROUND OF THE INVENTION

1. Field of the Invention

The present invention relates to a content distribution server and a content distribution method that are suitably applicable to content distribution with a bandwidth called NGN (Next Generation Network) for example guaranteed and with sessions managed by SIP (Session Initiation Protocol).

2. Description of the Related Art

Recently, band-ensured network services in which session management is executed by the SIP of a sophisticated network configuration called NGN to enable the mutual connection by use of unique terminal IDs such as telephone numbers have been developed and are being put into practical use. With NGN, it is slated to provide streaming services of video and so on, along with audio communication.

In order to provide streaming services, connect a content providing server that provides the streaming services to an NGN. Then, it is assumed that distribution services be carried out from that content providing server to many terminals connected to the NGN by use of a mechanism prepared for distribution. Arranging such a content providing server allows the broadcasting uniquely using NGN, thereby enabling the distribution of a variety of content.

Japanese Patent Laid-open No. 2006-293700 below discloses an example of processing in which content distributed from a content server is received to be relayed by a relay apparatus. In this example, the relay apparatus is equivalent to the above-mentioned content providing server

### SUMMARY OF THE INVENTION

With networks, such as NGN, data transmission and reception of some form from a particular user terminal to another user terminal requires the transmitting user terminal to make origination to an another user terminal identification ID, thereby establishing a session for data transmission and reception. Then, data is transferred by use of this connected session. Also, establishing a session with some server requires processing of making origination to that server and establishing a session therewith.

With the data transfer based on the connection for session establishment as described above, there is presented a problem that the transmitting user terminal is charged with network use fees, thereby imposing a high user burden. In addition, if there are two or more transmitting user terminals, sessions must be separately established for these user terminals, which requires sophisticated specifications capable of handling two or more sessions for two or more user terminals and the connection line for interconnecting the user terminals is required to have a band capable of handling two or more sessions. This poses barriers to be overcome for the realization of use forms for distributing video and so on uploaded directly from users. Further, in connecting user terminals with a content providing server provided by a business entity, the business entity having the content providing server has no mechanism for authenticating connecting users, making it difficult to realize the good transmission of content data by users. Still further, the resource management in the content providing server and the controlling of session switching after the occurrence of failure cannot be properly executed only by the mechanism of establishing a session always by the origination from the transmitting user terminal, thereby making it difficult to realize the good transmission of content data by users.

Therefore, the present invention addresses the above-identified and other problems associated with related-art methods and apparatuses and solves the addressed problems by providing the good transmission of content data by users through a network, such as NGN.

In carrying out the invention and according to one embodiment thereof, there is provided a content providing server. This content providing server has a content distribution processing block and a content reception processing block. The content distribution processing block configured to distribute, in multicast distribution, content data at least one reception terminal via a predetermined transmission path. The content reception processing block configured, in reception of a content distribution request via a predetermined connection line, to execute, via the connection line, callback on a content providing terminal that issued the received content distribution request and distribute, in multicast, content data obtained in a session connected by the callback from the content distribution processing block to the reception terminal.

In carrying out the invention and according to another embodiment thereof, there is provided a content distribution method. This method executes content distribution processing for distributing, in multicast distribution, content data at least one reception terminal via a predetermined transmission path. The content distribution processing is executed by the reception of a content distribution request via a predetermined connection line. Then, callback is executed on the content providing terminal that issued the received content distribution request and content data obtained by use of a session connected by the callback is distributed, in multicast, to the reception terminal by content distribution processing.

According to the above-mentioned embodiments of the invention, a content proving terminal that distributes content requests a predetermined content providing server for the establishment of a session by use of SIP (Session Initiation Protocol). Upon recognition of the session establishment request, the content providing server requests, by callback, the content providing terminal requested for session establishment to establish a session, thereby connecting the content providing terminal with the content providing server by the request from the content providing server. This establishes the session. When content data is transmitted to the content providing server by use of this connected session, the multicast distribution of content data from the content providing server is realized.

According to the above-mentioned embodiments of the invention, if content data is to be transmitted, a content providing terminal may only once request a server providing content in multicast for the establishment of a session and wait for callback from that server after disconnection. Content data is transmitted by use of the session connected by the callback, so that content data transmission can be executed without placing a burden, in terms of cost, to a user having a content providing terminal. In addition, the callback gives control to the server side for session start and a content providing terminal to be called back is a terminal registered beforehand, thereby providing authentication effects in which only registered terminals can be surely processed.

### BRIEF DESCRIPTION OF THE DRAWINGS

FIG. 1 is a block diagram illustrating an exemplary system configuration practiced as one embodiment of the invention;

FIG. 2 is a schematic diagram illustrating an exemplary transmission state practiced as the above-mentioned embodiment;

FIG. 3 is a sequence diagram illustrating an exemplary transmission state practiced as the above-mentioned embodiment (at the time of normal connection);

FIG. 4 is a sequence diagram illustrating an exemplary transmission state practiced as the above-mentioned embodiment (at the time of failed authentication);

FIG. 5 is a sequence diagram illustrating an exemplary transmission state practiced as the above-mentioned embodiment (at the time of disconnection from a content providing terminal);

FIG. 6 is a sequence diagram illustrating an exemplary transmission state of the above-mentioned embodiment (at the time of disconnection from a server);

FIG. 7 is a schematic diagram illustrating an exemplary transmission state practiced as another embodiment of the invention;

FIG. 8 is a sequence diagram illustrating an exemplary transmission state in the example shown in FIG. 7 (at the time of connection destination shift upon connection failure from server to terminal); and

FIG. 9 is a sequence diagram illustrating an exemplary transmission state in the example shown in FIG. 7 (at the time of connection destination shift upon occurrence of an abnormal state).

### DETAILED DESCRIPTION OF THE PREFERRED EMBODIMENTS

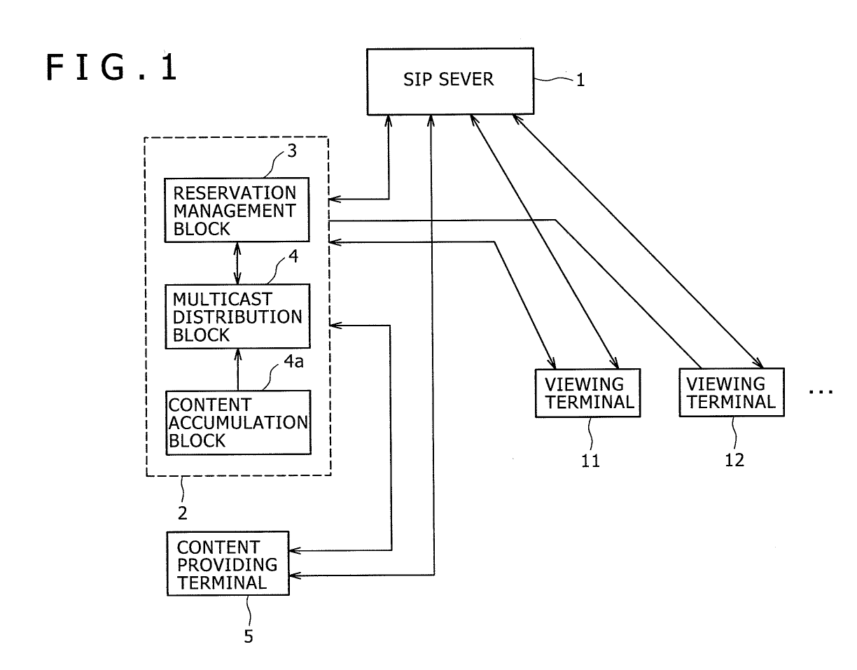

This invention will be described in further detail by way of embodiments thereof with reference to the accompanying drawings. The following describes one embodiment of the invention with reference to FIG. 1 through FIG. 6. The present embodiment is configured as a system that is connected to a network called NGN. The NGN is a bandwidth guaranteed network configured to have high-picture-quality television telephony and multicast distribution in addition to ordinary audio telephony, thereby providing high-picture-quality video distribution.

Now, referring to FIG. 1, there is shown a system configuration practiced as the embodiment of the present invention. A SIP server 1 is arranged on an NGN. Under the control of the SIP server 1, telephone origination and termination and viewing of various kinds of content are executed at viewing terminals 11, 12, and so on that are user terminals. The viewing terminals 11, 12, and so on may be terminals configured to view only content or configured to both view content and provide telephone functions. As for a connection line, the origination and termination based on IP address are controlled; namely, the connection line is configured as so-called IP telephone.

The network of the present embodiment is connected with a content distributor server 2. The content distributor server 2 is prepared by a content distributor. The content distributor server 2 has a reservation management block 3 and a multicast distribution block 4, in which the multicast distribution of content data from the multicast distribution block 4 to the NGN is controlled by the reservation management block 3. The multicast distribution block 4 distributes content data accumulated in a content accumulation block 4a. Also, the multicast distribution block 4 has a content reception block (not shown) configured to receive content transmitted in unicast via the connected connection line and has capabilities of distributing in multicast the content received at the reception block, without change. It should be noted that the content that is transmitted by the content distributor server 2 includes streaming data, such as video data and audio data, for example. If only the relay of content from a content providing terminal to be described later is executed, the content distributor server 2 need not have the content accumulation block 4a.

The content data transmitted in the multicast mode from the multicast distribution block 4 to the NGN can be received by any of the viewing terminals 11, 12, and so on to view the received content data without restriction. In the multicast distribution, content transmitted from the content distributor server 2 is received by each of the terminal without restriction, so that the connection of transmission path for unicast transmission need not be established between the content distributor server 2 and each of the viewing terminals 11, 12, and so on. However, some restriction may be imposed so as to allow only the terminals registered with the content distributor server 2 to view the received content.

In the present embodiment, the content providing terminal 5 is connected to the network. The content providing terminal 5 is a user terminal wants to transmit some content to any of the viewing terminals. For example, assumed for this user terminal is a terminal that distributes realtime video data taken with a video camera or a terminal that makes video content or audio content created by a user be transferred to another user, for example. The content providing terminal 5 is a terminal (having SIP capabilities) capable of connection to the content distributor server 2 for example by the origination in SIP using NGN.

In distributing content data from this content providing terminal 5, the present embodiment first transmits the content data to the content distributor server 2, from which the content data is distributed to the viewing terminals 11, 12, and so on.

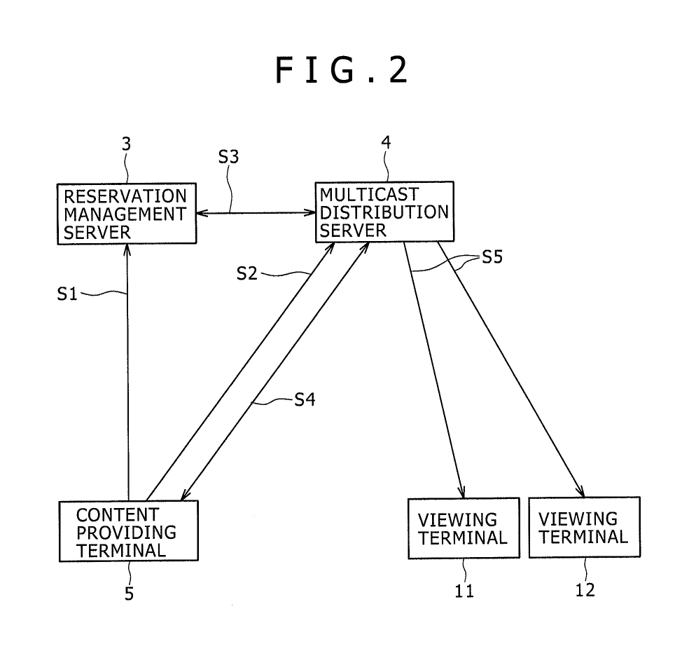

The following overviews, with reference to FIG. 2, the processing of distributing content data from the content providing terminal 5 shown in FIG. 1. As shown in FIG. 2, a content providing server and a multicast distribution server correspond to the reservation management block 3 and the multicast distribution block 4 in the content distributor server 2, respectively. In the example shown in FIG. 1, the reservation management block 3 and the multicast distribution block 4 are arranged in one server 2, for example; however, the reservation management block 3 and the multicast distribution block 4 may be arranged in separate servers. In what follows, the reservation management block and the multicast distribution block shown in FIG. 2 are also referred to as a reservation management block 3 and a multicast distribution block 4.

First, the content providing terminal 5 executes the processing of registering own terminal identification ID in the NGN (step S1). This registration of the terminal identification ID may be executed in advance rather than at the time of content distribution.

Next, the content providing terminal 5 transmits signaling that is a session connection request to the multicast distribution block 4, thereby request content provision (step S2). After the transmission of this content provision request to the multicast distribution block 4, the multicast distribution server transmits 180 response indicative of in-calling to the content providing terminal if the content provision request has been successfully authenticated; if the terminal authentication has failed, the multicast distribution server transmits 603 response indicative of termination rejected to the content providing terminal. If 180 response has been received by the content providing terminal, the content providing terminal 5 ends the session establishment request and disconnects the session, thereby becoming ready for a session connection request by callback from the multicast distribution server. It should be noted that 180 response and 603 response are the response numbers of responses specified in SIP, which holds the same with the responses described below.

The multicast distribution block 4 that has received the content provision request authenticates the content distributor server 2 for terminal information (step S3) and receives a request for session establishment, thereby making confirmation that the terminal that has made the content provision request is a terminal registered in advance by making a comparison with the terminal identification ID of originating terminal. This confirmation in step S3 and the response in step S2 are executed in parallel a shown in a sequence diagram to be shown later.

When this terminal authentication has been completed and session request is discontinued or disconnected by the terminal, the multicast distribution block 4 executes callback processing for transmitting a request to the content providing terminal 5 for session establishment, upon which the session is established. When this session has been established, the distribution of content from the content providing terminal 5 to the multicast distributor server starts. This transmission of content from the content providing terminal 5 to the multicast distribution block 4 is unicast transmission between the content providing terminal 5 and the multicast distribution block 4.

When the acquisition of content from the content providing terminal 5 starts at the multicast distribution block 4, the data of the received content is transmitted from the multicast distribution block 4 to the multicast addresses, upon which the viewing terminals 11, 12, and so on become ready for receiving the content data (step S5).

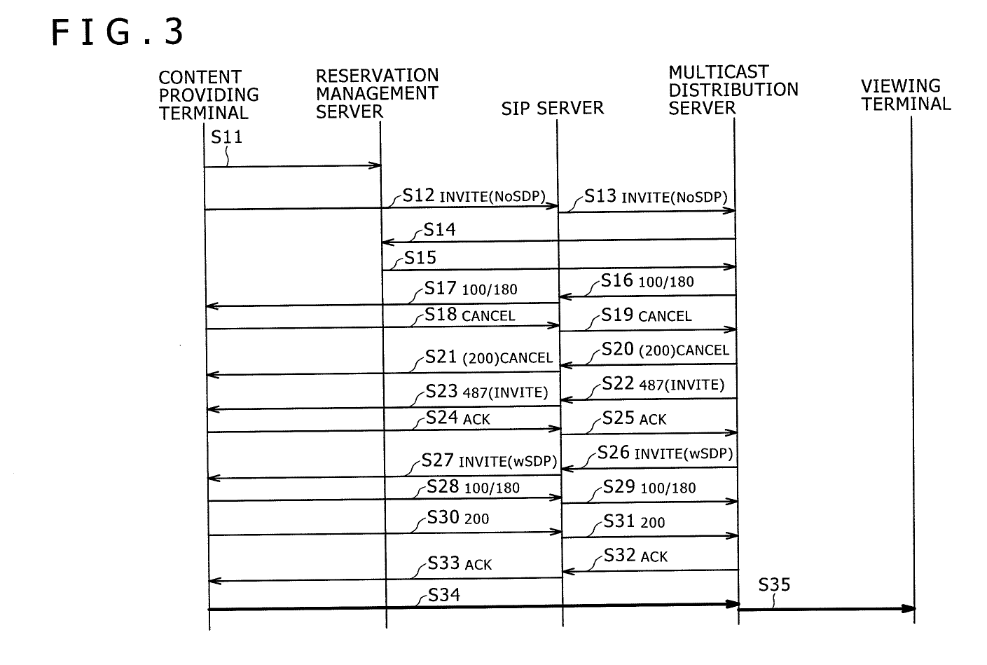

The following describes the detailed processing state of the processing overview shown in FIG. 2, with reference to the sequence diagrams of FIG. 3 through FIG. 6. FIG. 3 is a sequence diagram indicative of the start of connection. First, the content providing terminal 5 registers, with the reservation management block 3, the date of transfer of content in multicast distribution and the information about the content providing terminal 5 itself (step S11). This registration is executed by use of HTTP (Hyper Text Transfer Protocol) for example via the Internet.

Next, when a time comes at which the content is actually transmitted from the content providing terminal 5, a session establishment request is originated from the content providing terminal 5 to the terminal identification ID of the multicast distribution block 4 via the SIP server 1 (step S12 and step S13). This session establishment request is executed by transmitting an INVITE request; it is not necessary to add SDP (Session Description Protocol) including the codec information about the content to be transmitted.

The multicast distribution block 4 requested for session establishment immediately requests, by use of HTTP for example, the reservation management block 3 for authentication by use of the originating terminal identification ID of the terminal that has transmitted the INVITE request (step S14) and obtains the result of that authentication from the reservation management block 3 as a response to the HTTP request (step S15). At this moment, if the corresponding authentication is successful, the information about the terminal identification ID for a session establishment request and the callback registered as that terminal.

If the authentication is successful, in response to the session establishment request, 100 response indicative of in-processing and 180 response indicative of in-calling are transmitted to the content providing terminal 5 via the SIP server 1 (step S16 and step S17). When this 180 response is received by the content providing terminal 5, a CANCEL request for canceling a current call by dial is transmitted to the multicast distribution block 4 via the SIP server 1 (step S18 and step S19). When this CANCEL request is received by the multicast distribution block 4, 200 response indicative of a response to that cancellation of the dialing is transmitted (step S20 and step S21). Further, 487 response indicative of discontinuation of the INVITE request first received as a session establishment request is transmitted from the multicast distribution block 4 (step S22 and step S23) and an ACK request is transmitted in response (step S24 and step S25), upon which the processing of the session establishment request from step S12 ends.

Then, a session established request is transmitted from the multicast distribution block 4 that has confirmed the disconnection to the terminal identification ID of the content providing terminal 5 (step S26 and step S27). At the time of this session establishment request, the SDP is added that includes the information about a content type that is permitted for the transmission from the content providing terminal.

When this termination is detected by the content providing terminal 5, 100 response indicative of in-processing and 180 response indicative of in-calling are transmitted as the responses to the session establishment request (step S28 and step S29).

Further, 200 response indicative of the response to the termination at the content providing terminal 5 is transmitted with the SDP including the information about the content to be transmitted (step S30 and step S31). When an ACK request is returned in response (step S32 and step S33), the session between the multicast distribution block 4 and the content providing terminal 5 is established.

Next, by use of the established session, the transmission of content data (streaming data) from the content providing terminal 5 to the multicast distribution block 4 starts in unicast (step S34). The multicast distribution block 4 transmits the received content data (streaming data) to the multicast addresses such that two or more viewing terminals 11, 12, and so on can receive the content data (step S35). Thus, the transmission of streaming data starts, thereby continuously transmitting the streaming data for a predetermined reserved duration of time, for example.

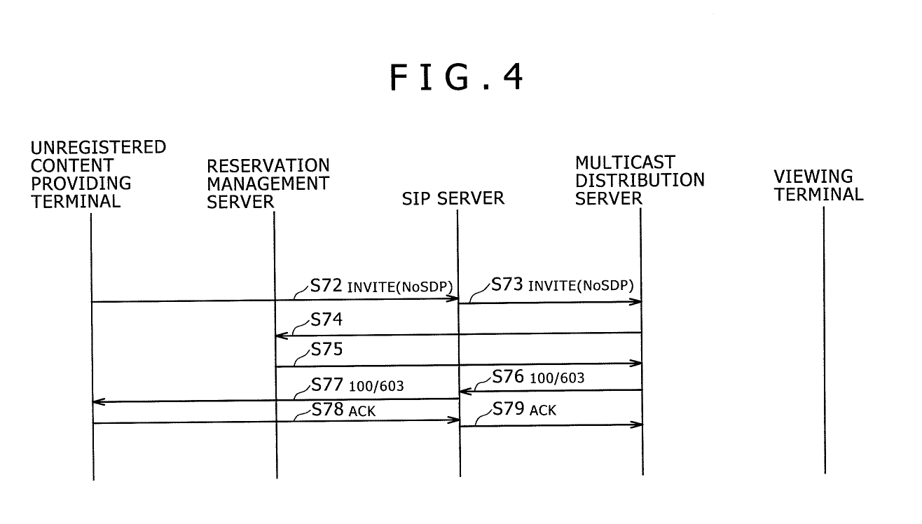

The following describes an example of processing to be executed if authentication fails on the multicast distribution block 4, with reference to FIG. 4.

This example assumes an operation of the content providing terminal 5 that has not been registered with the reservation management server.

A session establishment request is transmitted from the content providing terminal 5 to the terminal identification ID of the multicast distribution block 4 via the SIP server 1 (step S72 and step S73).

Receiving the session establishment request, the multicast distribution block 4 immediately requests, by use of HTTP for example, the reservation management block 3 for the authentication of the terminal identification ID to which the session establishment request was transmitted (step S74). In this example, it is assumed that the result of that authentication be originated from a terminal not correctly registered (step S75). At this moment, 603 response for example that is a response rejecting the termination is transmitted (step S76 and step S77) and an ACK request is transmitted from the content providing terminal 5 to that response (step S78 and step S79), upon which the processing comes to an end. In this case, the processing ends at this point of time, so that no callback from the multicast distribution block 4 is executed.

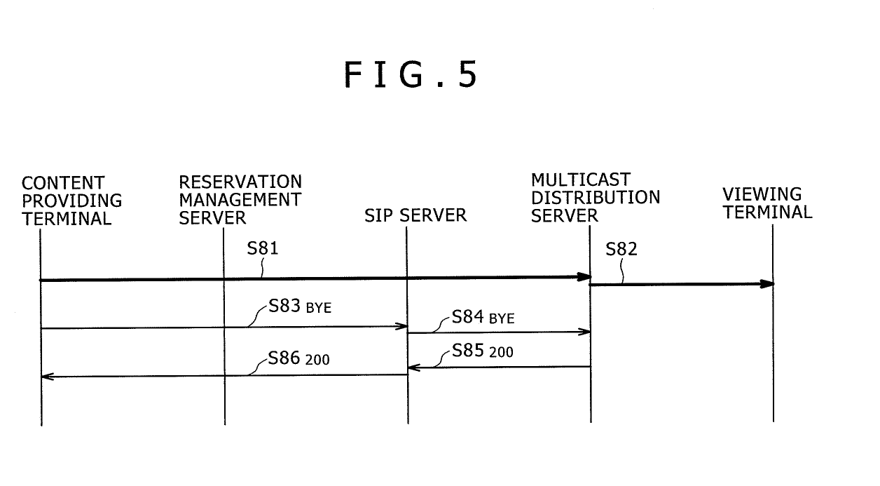

The following shows, with reference to FIG. 5, an exemplary sequence of processing for disconnecting the line from the content providing terminal 5 in a state in which content is being transmitted in the processing shown in FIG. 3.

In the example shown in FIG. 5, it is assumed that content data be being transmitted in unicast from the content providing terminal 5 to the multicast distribution block 4 by use of an established session (step S81). Also, it is assumed that, in the multicast distribution block 4, the received content data be transmitted to two or more viewing terminals 11, 12, and so on at multicast addresses (step S82).

In the above-mentioned state, a disconnection request (a BYE request) is transmitted from the content providing terminal 5 (step S83 and step S84) and, when 200 response to the BYE request is returned, the established session is ended, upon which the transmission of the streaming data comes to an end (step S85 and step S86).

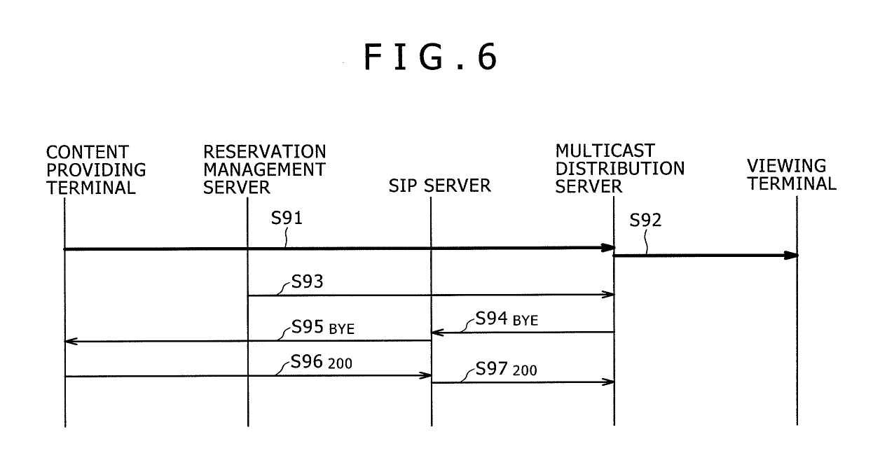

The example shown in FIG. 6 is an exemplary sequence in which a session is disconnected by the processing from the multicast distribution block 4 because of the passing of predetermined schedule time for example. In the example shown in FIG. 6, it is also assumed that content data be being transmitted in unicast from the content providing terminal 5 to the multicast distribution block 4 by use of an established session (step S91). Further, it is assumed that, in the multicast distribution block 4, the processing of transmitting the received content to two or more viewing terminals 11, 12, and so on at multicast addresses be being executed (step S92).

It is assumed, in the above-mentioned state, that a notification of the passing of reserved use time be transmitted from the reservation management block 3 to the multicast distribution block 4 by HTTP for example (step S93) If this notification is transmitted and the corresponding session is still being established, a request (a BYE request) is transmitted for the disconnection from the multicast distribution block 4 (step S94 and step S95). The established session is ended by returning 200 response that is the response to the BYE request, upon which the transmission of streaming data comes to an end (step S96 and step S97).

It should be noted that, in the procession operations described so far, the content providing terminal from which content data is transmitted is one; however, two or more terminals may be registered with the reservation management block 3 as terminals from which one identical piece of content data is transmitted.

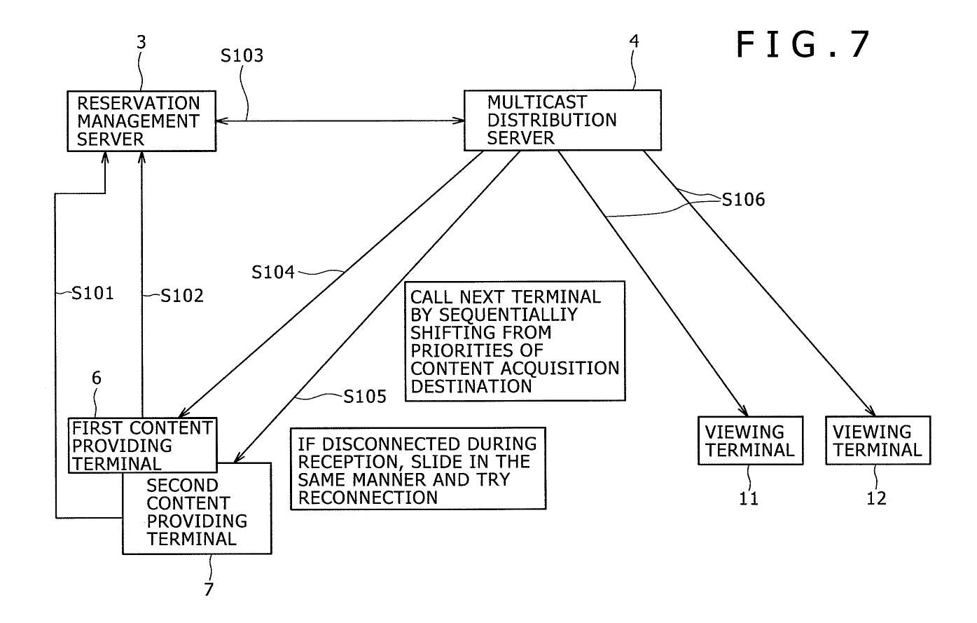

The example shown in FIG. 7 shows an overview of the processing to be executed when there are two or more content providing terminals. In this example, it is assumed that a first content providing terminal 6 and a second content providing terminal 7 be arranged and identical content data (identical streaming data) be transmitted therefrom.

In this case, the first and second content providing terminals 6 and 7 each first execute processing of registering own terminal IDs with the reservation management block 3 (step S101 and step S102).

It is assumed that, with the above-mentioned registration done, the first content providing terminal 6 request the multicast distribution block 4 for session establishment, thereby giving a content providing request, for example. When this content providing request has been transmitted to the multicast distribution block 4, the multicast distribution block 4 obtains terminal connection destination information from the reservation management block 3 (step S103). Then, the multicast distribution block 4 executes the callback processing as described above on the first content providing terminal but it is assumed that the session establishment fail for some reason (step S104).

If this failure occurs, the multicast distribution block 4 requests the second content providing terminal 7 that is another registered terminal for session establishment, thereby giving a content acquisition request, and it is assumed that the session establishment be successful (step S105).

If the session establishment is successful, the transfer of content data from the second content providing terminal 7 starts, thereby starting the transmission in multicast from the multicast distribution block 4 to each of the viewing terminals 11, 12, and so on (step S106). It should be noted that, if the session is discontinued for some failure after the start of the transfer from the first content providing terminal 6, a session establishment request based on this callback scheme may also be made, thereby switching to the transfer of content data from the second content providing terminal 7.

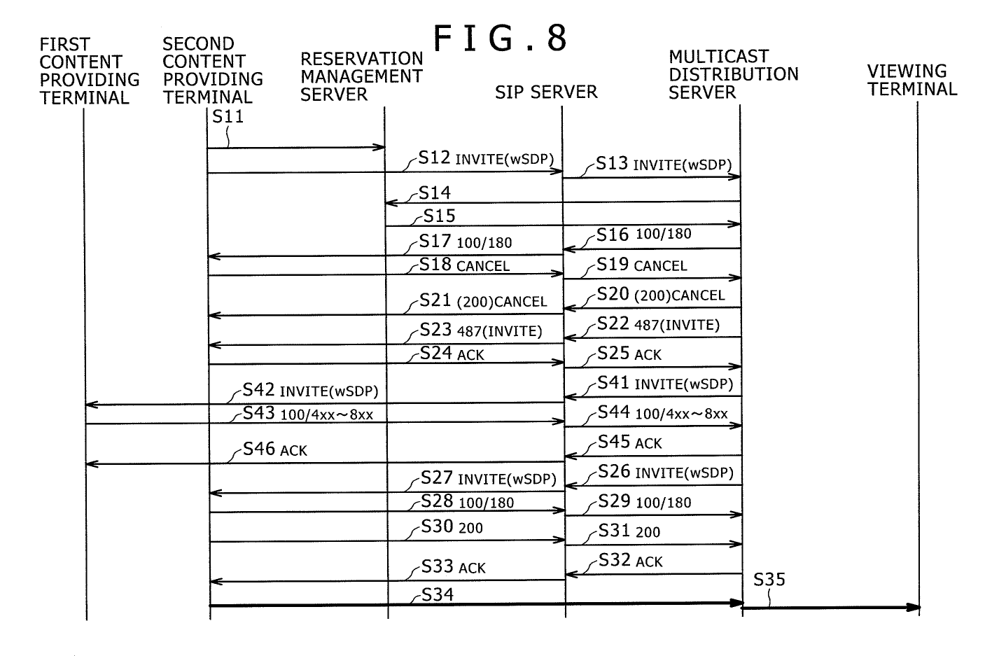

Referring to FIG. 8, there is shown a sequence diagram indicative of an example of processing to be executed if a session establishment request based on the callback scheme of one of two content providing terminals fails. With reference to FIG. 8, the processing operations similar to those previously described with reference to FIG. 3 are denoted by the same reference numerals.

First, the second content providing terminal 7 registers, with the reservation management block 3, the date of transferring content by multicast, own terminal information, and so on, by use of HTTP for example (step S11).

Next, when a time has been reached at which content is actually transmitted from the second content providing terminal, a session establishment request is transmitted from the second content providing terminal 7 to the terminal identification ID of the multicast distribution block 4 via the SIP server 1 (step S12 and step S13).

The multicast distribution block 4 requested for session establishment immediately requests, by use of HTTP for example, the reservation management block 3 for authenticating the terminal identification ID of the originating terminal that transmitted the session establishment request (step S14), thereby obtaining an authentication result from the reservation management block 3 as a response of HTTP for example (step S15). At this moment, if the authentication is successful, the multicast distribution block 4 also obtains a connected terminal list indicative of details of that terminal.

Then, if authentication is successful, 100 response indicative of in-processing and 180 response indicative of in-calling are transmitted to the second content providing terminal 7 via the SIP server 1 as the responses to the session establishment request (step S16 and step S17).

When this 180 response is confirmed by the second content providing terminal 7, a CANCEL request for canceling the call by the current session establishment request is transmitted to the multicast distribution block 4 via the SIP server 1 (step S18 and step S19). When this CANCEL request is received by the multicast distribution block 4, 200 response indicative of a signal for responding to the cancellation of that dialing is returned (step S20 and step S21). Further, 487 response indicative of discontinuation of the processing of the INVITE request first received as session establishment request is transmitted from the multicast distribution block 4 (step S22 and step S23) and an ACK request in response thereto is transmitted (step S24 and step S25), upon which the processing of the session established request from step S12 comes to an end.

Next, it is assumed that a session establishment request be transmitted from the multicast distribution block 4 to the terminal identification ID of the first content providing terminal 6 on the basis of the callback scheme (step S41 and step S42). At the time of this session establishment request, an SDP including the information about content type permitted for the transmission from the content providing terminal is added.

When this termination is detected by the first content providing terminal, 100 response indicative of in-processing and response such as 4xx response or 6xx response indicative of disconnection or rejection are transmitted (step S43 and step S44). Then, the call at this moment is discontinued when an ACK request as a response thereto is returned (step S45 and step S46).

The multicast distribution block 4 confirms from the information from the reservation management block 3 that one more content providing terminal has been registered. When this confirmation is made, a session establishment request is transmitted from the multicast distribution block 4 to the terminal identification ID of the corresponding terminal (the second content providing terminal 7) (step S26 and step S27).

When this termination is detected by the second content providing terminal 7, 100 response indicative of in-processing and 180 response indicative of in-calling are transmitted as the responses to the session establishment request (step S28 and step S29).

In continuation, 200 response indicative of a response to the termination at the second content providing terminal 7 is transmitted (step S30 and step S31) and an ACK request is returned in response thereto (step S32 and step S33), thereby establishing a session between the multicast distribution block 4 and the second content providing terminal 7.

Next, by use of the established session, the transmission of content data in unicast (streaming data) from the second providing terminal 7 to the multicast distribution block 4 starts (step S34). The multicast distribution block 4 transmits the received content data (streaming data) to two or more viewing terminals 11, 12, and so on at the multicast addresses (step S35). Thus, the transmission of streaming data starts and continues for a reserved duration of time for example.

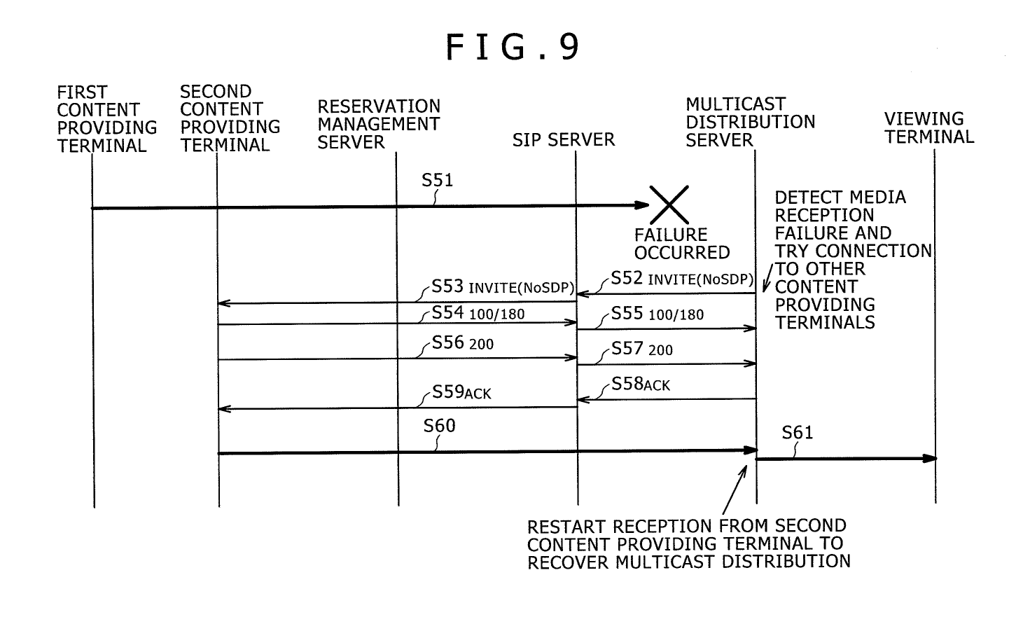

The following describes an example of processing to be executed if content providing terminals are switched upon the occurrence of a failure after the start of content data transfer with reference to a sequence diagram shown in FIG. 9.

In the example shown in FIG. 9, it is assumed that the transmission of content data in unicast from the first content providing terminal 6 to the multicast distribution block 4 be discontinued for some reason (step S51).

At this moment, when the multicast distribution block 4 confirms the presence of the other content providing terminal 7, the processing of establishing a session on that second content providing terminal 7 is executed.

Namely, a session establishment request is transmitted from the multicast distribution block 4 to the terminal identification ID of the second content providing terminal 7 (step S53 and step S54).

When this termination is detected by the second content providing terminal 7, 100 response indicative of in-processing and 180 response indicative of in-calling are transmitted as the responses to the session establishment request (step S54 and step S55).

In continuation, 200 response indicative of the response to the termination at the second content providing terminal 7 is transmitted (step S56 and step S57) and an ACK request as the response thereto is returned (step S58 and step S59), thereby establishing the session between the multicast distribution block 4 and the second content providing terminal 7.

Next, by use of the established session, the transmission of content data (the streaming data) in unicast from the second content providing terminal 7 to the multicast distribution block 4 starts (step S60). The multicast distribution block 4 transmits the received content data (the streaming data) to two or more viewing terminals 11, 12, and so on at the multicast addresses (step S61).

Thus, if the transmission is discontinued for some reason, the transmission of streaming data is restarted by use of other terminal.

As described above and according the embodiments of the present invention, the content providing terminal side waits for a callback from a multicast distribution server and transmits content data by use of a session established by that callback, thereby providing advantages of not placing a burden on the user having a content providing terminal in terms of cost and allowing the multicast distribution server side to control session start timing without restriction. In addition, a multicast distribution server carries out the distribution of content to two or more parties, thereby eliminating the necessity for the preparation of sophisticated specifications for each content providing terminal. Further, because the terminal that makes the callback is a terminal reserved in the reservation management block 3 (the reservation management server), the connection based on the callback is made only to a properly reserved terminal, thereby providing advantages of excluding illegal connection attempts.

As described with reference to FIGS. 7 through 9, because the above-mentioned configuration allows the registration of two or more content providing terminals, actions can easily be taken against failures.

In the above-mentioned embodiments, call control is executed on the basis of SIP called NGN, which is applicable to networks with bandwidth guarantee enabled; however, it is also practicable to apply the embodiments to various other networks including telephone lines.

Further, in addition to configuring as a dedicated apparatus, the server, such as the content distribution server, may be configured to function as a server that executes the processing operations described in the above-mentioned embodiments by installing software (program) for executing these processing operations onto a general-purpose computer.

The present application contains subject matter related to that disclosed in Japanese Priority Patent Application JP 2008-141306 filed in the Japan Patent Office on May 29, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A content providing server, comprising:
a content distribution processing block configured to distribute, in multicast distribution, content data at least one reception terminal via a predetermined transmission path; and
a content reception processing block configured, in reception of a content distribution request via a predetermined connection line, to execute, via said connection line, callback on a content providing terminal that issued the received content distribution request and distribute, in multicast, content data obtained in a session connected by said callback from said content distribution processing block to said reception terminal.

2. The content distribution server according to claim 1, further comprising
a reservation management block configured to register information associated with a terminal for managing information associated with said content providing terminal and, if a content distribution request from a registered terminal identification ID is received, executing callback in said content reception processing block, thereby establishing a session for content reception.

3. The content distribution server according to claim 1, wherein a plurality of terminal identification IDs are stored as the terminal identification ID of said and, if establishment of a session with a content reception terminal in callback to any one of the stored terminal identification IDS fails, reconnection is made to another terminal identification ID among the plurality of stored terminal identification IDs to establish a content reception session, thereby receiving the content data.

4. The content distribution server according to claim 1, wherein a plurality of terminal identification IDS are stored as the terminal identification ID of said and, if acquisition of content data is discontinued for some reason during the acquisition of content data, reconnection is made to another terminal identification ID among the plurality of stored terminal identification IDs to establish a content reception session, thereby receiving the content data.

5. The content distribution server according to claim 1, wherein a plurality of terminal identification IDs are stored as the terminal identification ID of said and, if acquisition of content data fails for some reason during the acquisition of content data, reconnection is made to another terminal identification ID among the plurality of stored terminal identification IDs to establish a content reception session, thereby receiving the content data.

6. The content distribution server according to claim 1, wherein a transmission path for distribution by said content distribution processing block in multicast is a connection line for connecting content data to a network enabled for multicast distribution.

7. A content distribution method comprising the steps of:
distributing, in multicast distribution, content data at least one reception terminal via a predetermined transmission path; and
in reception of a content distribution request via a predetermined connection line, executing, via said connection line, callback on a content providing terminal that issued the received content distribution request and distributing, in multicast, content data obtained in a session connected by said callback from said content distribution processing block to said reception terminal.

8. A content providing server, comprising:
content distribution processing means for distributing, in multicast distribution, content data at least one reception terminal via a predetermined transmission path; and
content reception processing means for, in reception of a content distribution request via a predetermined connection line, executing, via said connection line, callback on a content providing terminal that issued the received content distribution request and distributing, in multicast, content data obtained in a session connected by said callback from said content distribution processing means to said reception terminal.
